(19) United States
(12) Patent Application Publication
(10) Pub. No.: US 2004/0091801 A1
(43) Pub. Date: May 13, 2004

(54) Single layered electrophotographic photoreceptor

(75) Inventors: Hae-ree Joo, Seoul (KR); Beom-jun Kim, Gyeonggi-do (KR); Nam-Jeong Lee, Gyeonggi-do (KR); Hwan-koo Lee, Gyeonggi-do (KR); Saburo Yokota, Gyeonggi-do (KR); Kyung-yol Yon, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/612,418

(22) Filed: Jul. 3, 2003

(30) Foreign Application Priority Data
Jul. 16, 2002 (KR) 2002-41580

(51) Int. Cl. G03G 5/047

(52) U.S. Cl. 430/58.65; 430/64; 430/59.6; 430/59.4; 399/159

(57) ABSTRACT

An electrophotographic photoreceptor includes a support, an undercoating, and a photosensitive layer, wherein the undercoating includes a charge transport material which is soluble in an organic solvent and a binder resin.

### CROSS-REFERENCE TO RELATED APPLICATIONS

This application claims the benefit of Korean Application No. 2002-41580, filed Jul. 16, 2002, in the Korean Intellectual Property Office, the disclosure of which is incorporated herein by reference.

### BACKGROUND OF THE INVENTION

1. Field of the Invention

The present invention relates to electrophotographic photoreceptor, and more particularly, to an electrophotographic photoreceptor having a reduced image defect and improved electrical properties.

2. Description of the Related Art

In general, an electrophotographic photoreceptor includes a photosensitive layer having a charge generating material, a charge transport material and a binder resin, formed on a conductive substrate. In one embodiment of the photosensitive layers, function-separation type photoreceptors having a laminated structure in which a charge generating layer and a charge transport layer are laminated have been widely used.

In recent years, single layered photoreceptors have been manufactured by a simplified process providing effective chargeability that is used in positive corona discharge and generates a small amount of ozone. Thus, single layered photoreceptors have attracted considerable attention, and extensive studies are underway.

Representative examples of conventional single layered electrophotographic photoreceptors include a photoreceptor comprising a PVK/TNF charge transport complex as disclosed in U.S. Pat. No. 3,484,237, a photoreceptor comprising photoconductive phthalocyanine dispersed in a resin as disclosed in U.S. Pat. No. 3,397,086, a photoreceptor comprising a thiapyrylium and polycarbonate aggregate and a charge transport material dispersed in a resin as disclosed in U.S. Pat. No. 3,615,414. However, the photoreceptors disclosed therein do not have sufficient electrostatic properties and are considerably limited with respect to selection of materials. Also, since such materials are harmful, the materials are not utilized any longer.

Currently, single layered photoreceptors having a charge generating material, a hole transport material and an electron transport material dispersed in a resin, as described in Japanese Patent Publication 54-1633, have become the subject of development. Since such photoreceptors are functionally separated for charge generation and charge transport, a wide variety of materials may be selected. Also, since the concentration of the charge generating material may be reduced, functional, chemical durability of the photosensitive layer may be enhanced.

Although a photoreceptor having the above-described laminated structure may exert basic functions for image formation, a defect-free image is of higher importance. Also, effective image quality should be maintained even with repeated use for a prolonged period of time. However, in the case where an organic photosensitive layer is directly coated on a conductive support, an image defect is unavoidably generated due to electron injection from the conductive support, resulting in degradation of practicability of the photoreceptor. To overcome such problems, attempts have been made to perform anodic oxidation on a conductive support or to form an undercoating having a sub micron level thickness under a photosensitive layer. However, an image defect still remains to be resolved. In particular, in the case where the undercoating formed is as thick as 1 micron or greater, an image defect may be avoided, but migration of charges to be introduced into the conductive support is hindered, which increases an exposure potential, resulting in deterioration of electrical properties.

### SUMMARY OF THE INVENTION

An embodiment of the present invention provides an electrophotographic photoreceptor comprising a support, an undercoating and a photosensitive layer, wherein the undercoating includes a charge transport material which is soluble in an organic solvent and a binder resin.

The charge transport material used for the undercoating is preferably a compound represented by Formula 1:

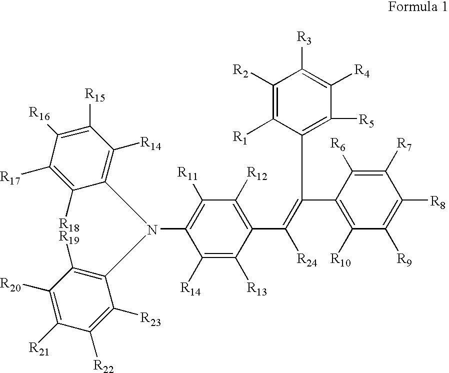

wherein R₁, R₂, R₃, R₄, R₅, R₆, R₇, R₈, R₉, R₁₀, R₁₂, R₁₂, R₁₃, R₁₄, R₁₅, R₁₆, R₁₇, R₁₈, R₁₉, R₂₀, R₂₁, R₂₂, R₂₃, and R₂₄ are independently selected from the group consisting of a hydrogen atom, a halogen atom, a hydroxy group, a carboxyl group, a cyano group, an amino group, a nitro group, a C₁-C₂₀ optionally substituted alkyl group, a C₆-C₃₀ optionally substituted aryl group, a C₁-C₂₀ optionally substituted halogenated alkyl group, a C₇-C₃₀ optionally substituted aralkyl group and a C₁-C₂₀ substituted alkoxy group.

The thickness of the undercoating is preferably about 1 to 5 μm.

Accordingly, it is an aspect of the present invention to provide an electrophotographic drum, comprising a drum; and an electrophotographic photoreceptor disposed thereon, the electrophotographic photoreceptor comprising a support; an undercoating; and a photosensitive layer, wherein the undercoating includes a charge transport material which is soluble in an organic solvent and a binder resin. The charge transport material in the undercoating may be a compound represented by Formula 1 (see above). The electrophotographic drum is typically attachable to/detachable from an image forming apparatus.

Accordingly, it is an aspect of the present invention to provide an electrophotographic cartridge, comprising an electrophotographic photoreceptor disposed on a drum, the electrophotographic photoreceptor comprising a support; an undercoating; and a photosensitive layer, wherein the undercoating includes a charge transport material which is soluble in an organic solvent and a binder resin; and at least one of: a charging device that charges the electrophotographic photoreceptor; a developing unit which develops an electrostatic latent image formed on the electrophotographic photoreceptor; and a cleaning device which cleans a surface of the electrophotographic photoreceptor, wherein the electrophotographic cartridge is attachable to/detachable from an image forming apparatus. The charge transport material in the undercoating may be a compound represented by Formula 1 (see above).

Accordingly, it is an aspect of the present invention to provide an image forming apparatus, comprising a photoconductor unit having an electrophotographic photoreceptor, the electrophotograpohic photoconductor comprising: a support; an undercoating; and a photosensitive layer, wherein the undercoating includes a charge transport material which is soluble in an organic solvent and a binder resin; and a charging device which charges the photoconductor unit; an imagewise light irradiating device which irradiates the charged photoconductor unit with imagewise light to form an electrostatic latent image on the photoconductor unit; a developing unit that develops the electrostatic latent image with a toner to form a toner image on the photoconductor unit; and a transfer device which transfers the toner image onto a receiving material, The charge transport material in the undercoating may be a compound represented by Formula 1 (see above).

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments taken in conjunction with the accompanying drawings, of which:

FIG. 1 is a block diagram illustrating (not to scale) an electrophotographic photoreceptor having an undercoating and being installed on a conductive substrate in accordance with the present invention.

FIG. 2 is a schematic representation of an image forming apparatus, an electrophotgraphic drum, and an electrophographic cartridge in accordance with selected embodiments of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In an embodiment of the present invention, the photoreceptor of the present invention includes an undercoating and a photosensitive layer on a support, and the undercoating includes a charge transport material, which is soluble in an organic solvent, and a binder resin. The undercoating disposed between the support and the photosensitive layer as an intermediate layer minimizes an image defect by preventing introduction of electrons into the photosensitive layer from the support, and suppresses an increase in exposure potential caused by the thickness of the undercoating by adding a charge transport material, thus improving electrical properties of the photoreceptor.

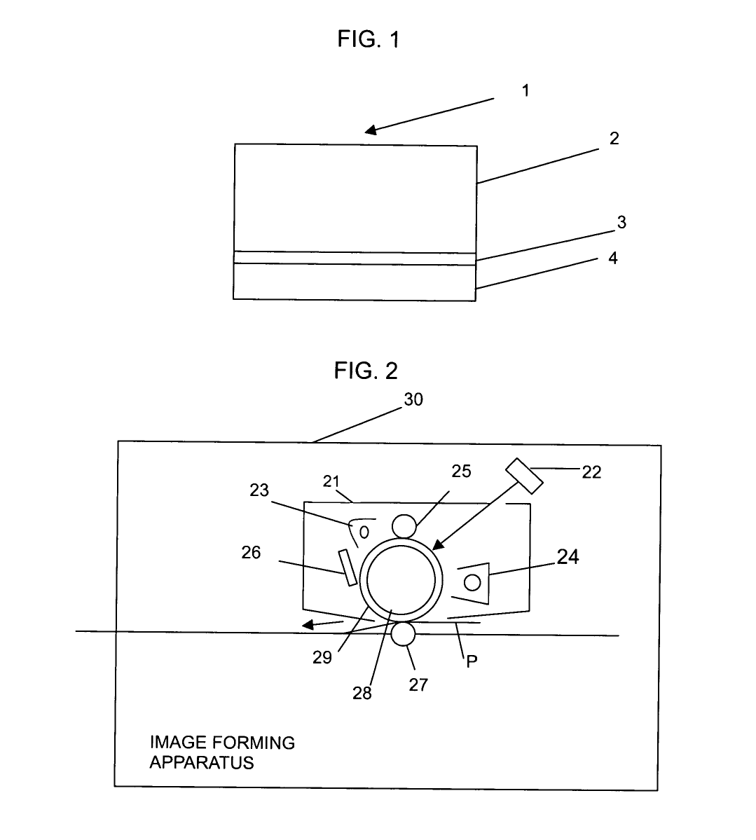

FIG. 1 is a block diagram illustrating (not to scale) an electrophotographic photoreceptor 1 having a photosensitive layer 2 with an undercoating 3 wherein the photoreceptor is installed on a conductive substrate 4 in accordance with the present invention, as described more specifically below.

In an embodiment of the present invention, the charge transport material used for the undercoating is preferably a compound represented by Formula 1:

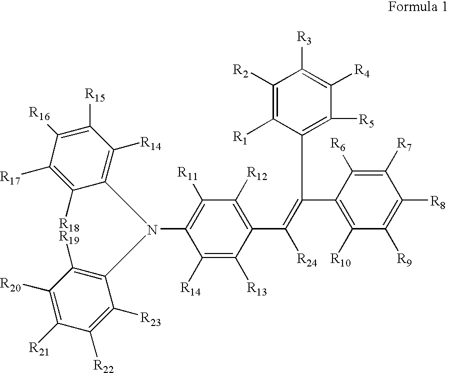

wherein R₁, R₂, R₃, R₄, R₅, R₆, R₇, R₈, R₉, R₁₀, R₁₁, R₁₂, R₁₃, R₁₄, R₁₅, R₁₆, R₁₆, R₁₇, R₁₈, R₁₉, R₂₀, R₂₁, R₂₂, R₂₃, and R₂₄ are independently selected from the group comprising a hydrogen atom, a halogen atom, a hydroxy group, a carboxyl group, a cyano group, a amino group, a nitro group, a C₁-C₂₀ optionally substituted alkyl group, a C₆-C₃₀ optionally substituted aryl group, a C₁-C₂₀ optionally substituted halogenated alkyl group, a C₇-C₃₀optionally substituted aralkyl group and a C₁-C₂₀ optionally substituted alkoxy group.

In Formula 1, the alkyl group includes a C₁-C₂₀ linear or branched radical, preferably a C₁-C₁₂ linear or branched radical, more preferably a C₁-C₈ alkyl. Examples of the radical include methyl, ethyl, n-propyl, isopropyl, n-butyl, isobutyl, sec-butyl, t-butyl, pentyl, iso-amyl, hexyl and octyl. C₁-C₃ lower alkyl radicals are more preferred.

The alkoxy group includes an oxygen-containing, straight or branched radical having C₁-C₂₀ alkyl, preferably a C₁-C₆ lower alkoxy radical. Examples of the radical include methoxy, ethoxy, propoxy, butoxy, t-butoxy and the like. The alkoxy radical is further substituted by at least one halo atom such as fluorine, chlorine or bromine, providing a haloalkoxy radical. A C₁-C₃ lower haloalkoxy radical is more preferred. Examples of the halogenated alkyl radical residual potential include fluoromethoxy chloromethoxy, trifluoromethoxy, trifluoroethoxy, fluoroethoxy and fluoropropoxy.

The aryl group, alone or in combination, means a C₆-C₂₀ carbocyclic aromatic system containing one or more rings which may be bonded together in a pendent manner or may be fused. Examples of the aryl group include aromatic radicals such as phenyl, naphthyl, or biphenyl. Phenyl is generally preferred. The aryl group may have one to three substituents selected from hydroxy, halo, halogenated alkyl, cyano and lower alkylamino and the like.

The aralkyl group means a substituted alkyl group with one or more hydrogen atoms substituted by a lower alkyl radical such as methyl, ethyl or propyl. Examples of the aralkyl group include benzyl and phenylethyl.

The halogenated alkyl group means a substituted alkyl group with one or more hydrogen atoms further substituted by halogen atoms such as fluoro, chloro or bromo. Examples of the halogenated alkyl group include fluoromethyl and chloroethyl.

Preferred examples of the compound of Formula 1 include a compound represented by Formula 2:

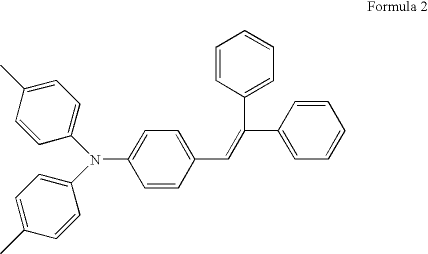

As a solvent for dissolving the charge transport material for the undercoating, an alcoholic solvent, a halogenated solvent or a cosolvent thereof, more preferably, 2-chloroethanol, 1,1,2-trichloroethane/dichloromethane or 2-chloroethanol/dichloromethane is preferred.

Any alcohol-based solvent that is generally used in the art may be used without limitation, and 2-chloroethanol is preferred. As the halogenated solvent, 1,1,2-trichloroethane, chloroform, dichloromethane or dichloroethane is preferably used. Dichloromethane is more preferred.

As the binder resin for the undercoating, any binder resin that is generally used for a general photoreceptor may be used without limitation, and examples thereof include polycarbonate, polyester, methacryl resin, acryl resin, polyvinyl chloride, polyvinylidene chloride, polystyrene, polyvinyl acetate, silicon resin, silicon-alkyd resin, styrene-alkyd resin, poly-N-vinylcarbazole, phenoxy resin, epoxy resin, polyvinyl butyral, polyvinyl acetal, polyvinyl formal, polysulfone, polyvinyl alcohol, ethyl cellulose, phenol resin, polyamide, carboxy-metal cellulose and polyurethane. The polymers may be used alone or in combination. Specifically, polyamide resin is preferred. More preferred examples of the binder resin include polyamide copolymer having ether bonds in the molecular structure or having aliphatic or heteroatom rings which may have lower alkyl groups, as the main components.

The undercoating preferably has a thickness of about 1 to 5 μm. If the thickness of the undercoating is less than 1 μm, electron introduction into the photosensitive layer from the support may not be suppressed sufficiently. If the thickness of the undercoating is greater than 5 μm, an exposure potential may increase, resulting in deterioration of electrical properties.

In general, the electrophotographic photoreceptor includes a photosensitive layer coated on a support. As the support, a metal or plastic, drum- or belt-shaped support is used.

The photosensitive layer may be a laminated type in which a charge generating layer and a charge transport layer are stacked, or alternatively, the photosensitive layer may be a single layered type with both charge generating and transporting functions.

Examples of the charge generating material for the photosensitive layer include organic materials such as phthalocyanine pigment, azo pigment, quinone pigment, perylene pigment, indigo pigment, bisbenzoimidazole pigment, quinacridone pigment, azulenium dye, squarylium dye, pyrylium dye, triarylmethane dye, cyanine dye, and inorganic materials such as amorphous silicon, amorphous selenium, trigonal selenium, tellurium, selenium-tellurium alloy, cadmium sulfide, antimony sulfide or zinc sulfide. The charge generating materials are not limited to the materials listed herein, and may be used alone or in combination of 2 or more in mixtures thereof.

In the case of the laminated type photoreceptor, the charge generating layer is formed by dispersing the charge generating material and the binder resin in a solvent and coating the same, or forming a layer by vacuum deposition, sputtering or chemical vapor deposition (CVD). The thickness of the charge generating layer is generally in the range of 0.1 to 1.0 μm. If the thickness of the charge generating layer is less than 0.1 μm, charge generation may not be sufficient. If the thickness of the charge generating material is greater than 1.0 μm, dark decay may be severe, lowering the efficiency of the photoreceptor.

The binder resin in the photosensitive layer includes, but is not limited to, electrically insulating polymers, for example, polycarbonate, polyester, methacryl resin, acryl resin, polyvinyl chloride, polyvinylidene chloride, polystyrene, polyvinyl acetate, silicon resin, silicon-alkyd resin, styrene-alkyd resin, poly-N-vinylcarbazole, phenoxy resin, epoxy resin, polyvinyl butyral, polyvinyl acetal, polyvinyl formal, polysulfone, polyvinyl alcohol, ethyl cellulose, phenol resin, polyamide, carboxy-metal cellulose and polyurethane. The polymers may be used alone or in combination of two or more kinds of these materials.

In the case of a single type layered photoreceptor, a photosensitive layer is obtained by dispersing the charge generating material, the binder resin and the charge transport material in a solvent and coating the resulting product on a substrate. In this case, the charge transport material includes a hole transport material and an electron transport material.

Examples of the hole transport material that may be used in the photosensitive layer include nitrogen-containing cyclic compounds or condensed polycyclic compounds such as pyrene compounds, carbazole compounds, hydrazone compounds, oxazole compounds, oxadiazole compounds, pyrazoline compounds, arylamine compound, arylmethane compounds, benzidine compounds, thiazole compounds or styryl compounds. Polymer compounds or polysilane compounds having the forefoing substituents may also be used, but the hole transport material is not limited thereto.

Examples of the electron transport material that may be used in the photosensitive layer include, but are not limited to, electron attracting low-molecular weight compounds such as benzoquinone compounds, cyanoethylene compounds, cyanoquinodimethane compounds, fluorenone compounds, xanthones compounds, phenanthraquinone compounds, anhydrous phthalic acid compounds, thiopyrane compounds or diphenoquinone compounds. Electron transporting polymer compounds or pigments having n-type semiconductor characteristics may also be used.

The charge transport material or hole transport material that may be used for the electrophotographic photoreceptor according to an embodiment of the present invention is not limited to the materials listed herein, and the cited materials may be used alone or in combination.

The thickness of the photosensitive layer of either a laminated type or a single layered type, is generally in the range of 5 to 50 um. Examples of solvents used in the coating technique include organic solvents such as alcohols, ketones, amides, ethers, esters, sulfones, aromatics, aliphatic halogenated hydrocarbons and the like. Examples of the coating technique include a dip coating method, a ring coating method, a roll coating method or a spray coating method, but any coating technique may be applied to the electrophotographic photoreceptor according to the present invention.

In the laminated type or single layered type photoreceptor, the content of the binder resin is 0.5 to 2 parts by weight based on 1 part by weight of the charge transport material. If the content of the binder resin to the charge transport material is less than 0.5 parts by weight, a relative concentration of the resin contained in the photosensitive layer is undesirably small. If the content of the binder resin is greater than 2 parts by weight, an insufficient charge transporting capability results, so that the sensitivity is low, and the residual potential increases.

In an embodiment of the present invention, in order to suppress formation of interface bands and to compensate for damages to a support substrate, a conductive layer may be further formed between the support substrate and a photosensitive layer. The conductive layer is obtained by dispersing conductive powder such as carbon black, graphite, metallic powder or metal oxide powder in a solvent, coating the dispersion liquid on the support substrate and drying the resulting product. The thickness of the conductive layer is preferably in the range of 5 to 50 μm.

The photosensitive layer may contain, in addition to the binder resin, a plasticizer, a leveling agent, a dispersion-stabilizing agent, an antioxidant or a photo-stabilizing agent.

Examples of the antioxidant include phenol compounds, sulfur compounds, phosphorus compounds or amine compounds.

Examples of the photo-stabilizing agent include benzotriazol compounds, benzophenone compound, or hindered amine compounds.

The present invention is explained in detail hereinbelow with reference to examples. However, it should be understood that the invention is not limited to such specific examples.

The photoreceptor according to the present invention may be applied to copiers, laser printers, CRT printers, LED printers, LCD printers, laser electrophotography and the like. In particular, the photoreceptor according to the present invention may be advantageously used for liquid toners for electrophotographic development.

In the examples and comparative examples, all“parts” and“%” mean“parts by weight” and“% by weight”, respectively.

### EXAMPLE 1

### Formation of Undercoating

0.25 g of polyamide (CM8000, manufactured by AMILAN TORAY NYLON), 0.25 g of a compound of Formula 2 (HCT202, manufactured by HODOGAYA) as a charge transporting material were dissolved in a cosolvent of 6.65 g of 2-chloroethanol and 2.85 g of dichloromethane, filtered (pore size=1 μm) and coated on an aluminum drum using a ring coater at a speed of 300 mm/min, followed by drying at 120° C. for 30 minutes, giving an undercoating having a thickness of approximately 2 microns.

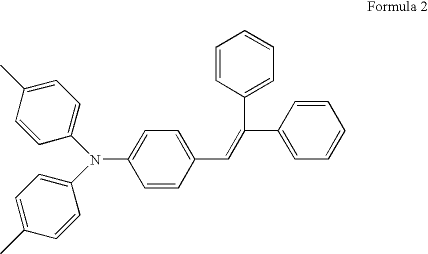

### Formation of Photosensitive Layer

Composition

| | |
|---|---|
| [symbol] -titanyl phthalocyanine ( [symbol] -TiOPc, H.W. SANDS): | 8 parts |
| Hole transport material (MPCT10, | 30 parts |
| MITSUBISHI PAPER MILLS): | |
| Electron transport material (BCMF, | 20 parts |
| SAMSUNG IMAGING LAB.): | |
| Binder (O-PET, KANEBO): | 60 parts |
| Antioxidant (IRGANOX 1010, CIBA): | 11.8 parts |

All components except y -titanyl phthalocyanine in the composition were dissolved in 460.2 parts of a cosolvent of 1,1,2-trichloroethane/dichloromethane (4/6). The mixture product was added to milled y-titanyl phthalocyanine for dispersion, filtered (pore size=5 μm) and coated on the undercoating using a ring coater at a speed of 300 mm/min, followed by drying at 110 for 60 minutes, giving a 12 μm thick photosensitive layer, thus completing a photoreceptor.

### COMPARATIVE EXAMPLE 1

### Formation of Photosensitive Layer

Composition

| | |
|---|---|
| [symbol] -titanyl phthalocyanine ( [symbol] -TiOPc, H.W. SANDS): | 8 parts |
| Hole transport material (MPCT10, | 30 parts |
| MITSUBISHI PAPER MILLS): | |
| Electron transport material (BCMF, | 20 parts |
| SAMSUNG IMAGING LAB.): | |
| Binder (O-PET, KANEBO): | 60 parts |
| Antioxidant (IRGANOX 1010, CIBA): | 11.8 parts |

All components except y-titanyl phthalocyanine in the composition were dissolved in 460.2 parts of a cosolvent of 1,1,2-trichloroethane/dichloromethane (4/6). The mixture was added to milled y-titanyl phthalocyanine for dispersion, filtered (pore size=5 μm) and coated on an aluminum drum using a ring coater at a speed of 300 mm/min, followed by drying at 110 um for 60 minutes, giving a 12 μm thick photosensitive layer on an aluminum drum, thus completing a photoreceptor.

### COMPARATIVE EXAMPLE 2

### Formation of Undercoating

0.3 g of polyamide (CM8000, manufactured by AMILAN TORAY NYLON) was dissolved in 9.7 g 2-chloroethanol, filtered (pore size=1 μm) and coated using a ring coater at a speed of 300 mm/min, followed by drying at 120° C. for 30 minutes, giving an undercoating having a thickness of 1 micron or less on an aluminum drum.

### Formation of Photosensitive Layer

Composition

| | | |
|---|---|---|
| γ-titanyl phthalocyanine (γ-TiOPc, H.W. SANDS): | 8 | parts |
| Hole transport material (MPCT10, | 30 | parts |
| MITSUBISHI PAPER MILLS): | | |
| Electron transport material (BCMF, | 20 | parts |
| SAMSUNG IMAGING LAB.): | | |
| Binder (O-PET, KANEBO): | 60 | parts |
| Antioxidant (IRGANOX 1010, CIBA): | 11.8 | parts |

All components except y-titanyl phthalocyanine in the composition were dissolved in 460.2 parts of a cosolvent of 1,1,2-trichloroethane/dichloromethane (4/6). The mixture was added to milled y-titanyl phthalocyanine for dispersion, filtered (pore size=5 μm) and coated using a ring coater at a speed of 300 mm/min, followed by drying at 110° C. for 60 minutes, giving a 12 μm thick photosensitive layer on the undercoating, thus completing a photoreceptor.

### COMPARATIVE EXAMPLE 3

### Formation of Undercoating

0.5 g of polyamide (CM8000, manufactured by AMILAN TORAY NYLON) was dissolved in 9.5 g 2-chloroethanol, filtered (pore size=1 μm) and coated using a ring coater at a speed of 300 mm/min, followed by drying at 120° C. for 30 minutes, giving an undercoating having a thickness of approximately 2 microns on an aluminum drum.

### Formation of Photosensitive Layer

Composition

| | |
|---|---|
| [symbol] -titanyl phthalocyanine ( [symbol] -TiOPc, H.W. SANDS): | 8 parts |
| Hole transport material (MPCT10, | 30 parts |
| MITSUBISHI PAPER MILLS): | |
| Electron transport material (BCMF, | 20 parts |
| SAMSUNG IMAGING LAB.): | |
| Binder (O-PET, KANEBO): | 60 parts |
| Antioxidant (IRGANOX 1010, CIBA): | 11.8 parts |

All components except y-titanyl phthalocyanine in the composition were dissolved in 460.2 parts of a cosolvent of 1,1,2-trichloroethane (4)/dichloromethane (6). The mixture was added to milled γ-titanyl phthalocyanine for dispersion, filtered (pore size =5 μm) and coated on the undercoating using a ring coater at a speed of 300 mm/min, followed by drying at 110° C. for 60 minutes, giving a 12 μm thick photosensitive layer, thus completing a photoreceptor.

### TEST EXAMPLE 1

### Image Evaluation

It was determined whether an image defect occurred to on images obtained by printing using liquid toner developing devices manufactured by the electrophotographic photoreceptors formed in Example 1, Comparative Examples 1-3. That is, it was determined whether minute spots were generated at the images, and the results are shown in Table 1, with a charge potential set to 900 V.

TABLE 1

| | | Comparative | Comparative | Comparative |
|---|---|---|---|---|
| | Example 1 | Example 1 | Example 2 | Example 3 |
| Image | Not | Occurred | Occurred | Not occurred |
| defect | occurred | | | |

As shown in Table 1, the image evaluation result showed that in Comparative Example 1 without an undercoating and Comparative Example 2 with an undercoating having a thickness of 1 micron or less, an image defect was generated, that is, minute spots occurred to an image. However, if the photoreceptor has an undercoating having a thickness of greater than 1 micron as in Example 1 and Comparative Example 3, no image defect was generated.

### TEST EXAMPLE 2

### Evaluation of Electrical Properties

The photoreceptors formed in Example 1 and Comparative Examples 1 and 3 were exposed with a charge potential of 8 kV and an exposure energy of 1 μJ/cm² and electrical properties such as exposure potentials were evaluated using a charger (PDT2000, QEA), and the results are shown in Table 2.

TABLE 2

| | Example 1 | Comparative | Comparative |
|---|---|---|---|
| | (Undercoating with | Example 1 | Example 3 |
| | polyamide and hole | (Without | (Undercoating with |
| | transport material) | undercoating) | polyamide only) |
| Charge | 562 | 547 | 551 |
| potential (V) | | | |
| Exposure | 78 | 74 | 113 |
| potential (V) | | | |

As shown in Table 2, in the photoreceptor according to the present invention, since the undercoating having a thickness of approximately 2 microns serves as a blocking layer, electron injection to the photosensitive layer from a support may be suppressed. While the photoreceptor of Comparative Example 3 without a charge transport material showed a considerable increase in exposure potential, the photoreceptor of Example 1 with a charge transport material contained in the undercoating showed little increase in exposure potential as in Comparative Example 1 without undercoating, that is, showed stable electrical properties.

As described above, the electrophotographic photoreceptor according to the present invention has improved electrical properties by minimizing occurrence of an image defect by suppressing electron injection from a support to a photosensitive layer while suppressing an increase in exposure potential by employing an undercoating having a charge transport material. Therefore, the photoreceptor according to the present invention may be applied to copiers, laser printers, CRT printers, LED printers, LCD printers, laser electrophotography and the like. In particular, the photoreceptor according to the present invention may be advantageously used for liquid toners for electrophotographic development.

As shown in FIG. 2, the present invention may be utilized in an electrophotographic cartridge 21, an electrophotographic photoconductor drum 28, 29, or in an image forming apparatus 30. The electrophotographic cartridge 21 typically comprises an electrophotographic photoconductor 29 and at least one of a charging device 25 that charges the electrophotographic photoconductor 29, a developing device 24 which develops an electrostatic latent image formed on the electrophotographic photoconductor 29, and a cleaning device 26 which cleans a surface of the electrophotographic photoconductor 29. The electrophotographic cartridge 21 may be attached to or detached from the image forming apparatus 30, and the electrophotographic photoconductor 9 is described more fully above.

The electrophotographic photoconductor drum 28, 29 for an image forming apparatus 30, generally includes a drum 28 that is attachable to and detachable from the electrophotographic apparatus 30 and that includes an electrophotographic photoconductor 29 installed thereon, wherein the electrophotographic photoconductor 29 is described more fully above.

Generally, the image forming apparatus 30 includes a photoconductor unit (e.g., an electrophotographic photoconductor drum 28, 29), a charging device 25 which charges the photoconductor unit, an imagewise light irradiating device 22 which irradiates the charged photoconductor unit with imagewise light to form an electrostatic latent image on the photoconductor unit, a developing unit 24 that develops the electrostatic latent image with a toner to form a toner image on the photoconductor unit, and a transfer device 27 which transfers the toner image onto a receiving material, such as paper P, wherein the photoconductor unit comprises an electrophotographic photoconductor 29 as described in greater detail above. The charging device 25 may be supplied with a voltage as a charging unit and may contact and charge the electrophotographic conductor. Where desired, the apparatus may include a pre-exposure unit 23 to erase residual charge on the surface of the electrophotographic photoconductor to prepare for a next cycle.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrophotographic photoreceptor comprising:
a support;
an undercoating; and
a photosensitive layer,
wherein the undercoating includes a charge transport material which is soluble in an organic solvent and a binder resin.

2. The electrophotographic photoreceptor of claim 1, wherein the charge transport material in the undercoating is a compound represented by Formula 1: 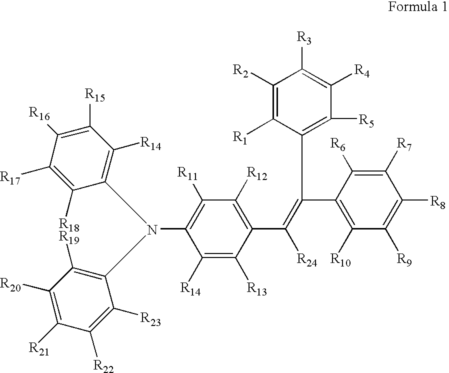
wherein R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉, R₂₀, R₂₁, R₂₂ R₂₃ and R₂₄ are independently selected from the group consisting of a hydrogen atom, a halogen atom, a hydroxy group, a carboxyl group, a cyano group, a amino group, a nitro group, a C₁-C₂₀ optionally substituted alkyl group, a C₆-C₃₀ optionally substituted aryl group, a C₁-C₂₀ optionally substituted halogenated alkyl group, a C₇-C₃₀ optionally substituted aralkyl group and a C₁-C₂₀ optionally substituted alkoxy group.

3. The electrophotographic photoreceptor of claim 2, wherein the compound represented by Formula 1 is a compound represented by Formula 2:

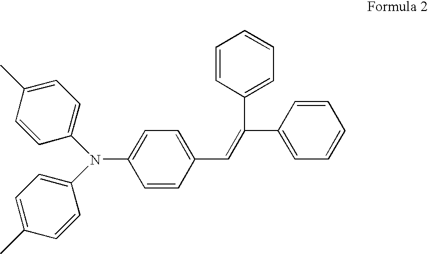

4. The electrophotographic photoreceptor of claim 1, wherein the solvent for dissolving the charge transport material in the undercoating is an alcoholic solvent, a halogenated solvent or a cosolvent thereof.

5. The electrophotographic photoreceptor of claim 4, wherein the alcohol-based solvent is 2-chloroethanol.

6. The electrophotographic photoreceptor of claim 4, wherein the halogenated solvent is one of 1,1,2-trichloroethane, chloroform, dichloromethane and dichloroethane.

7. The electrophotographic photoreceptor of claim 1, wherein the binder resin in the undercoating is at least one selected from the group consisting of polycarbonate, polyester, methacryl resin, acryl resin, polyvinyl chloride, polyvinylidene chloride, polystyrene, polyvinyl acetate, silicon resin, silicon-alkyd resin, styrene-alkyd resin, poly-N-vinylcarbazole, phenoxy resin, epoxy resin, polyvinyl butyral, polyvinyl acetal, polyvinyl formal, polysulfone, polyvinyl alcohol, ethyl cellulose, phenol resin, polyamide, carboxy-metal cellulose and polyurethane, and mixtures thereof.

8. The electrophotographic photoreceptor of claim 7, wherein the binder resin is a polyamide resin.

9. The electrophotographic photoreceptor of claim 1, wherein the thickness of the undercoating is in a range of 1 to 5 μm.

10. The electrophotographic photoreceptor of claim 1, wherein the photosensitive layer is a single layered structure in which a charge generating material, an electron transport material and a hole transport material are included.

11. The electrophotographic photoreceptor of claim 1, wherein the photosensitive layer is a laminated structure including a charge generating layer and a charge transport layer.

12. The electrophotographic photoreceptor of claim 10, wherein the charge generating material in the photosensitive layer is at least one selected from the group consisting of phthalocyanine pigment, azo pigment, quinone pigment, perylene pigment, indigo pigment, bisbenzoimidazole pigment, quinacridone pigment, azulenium dye, squarylium dye, pyrylium dye, triarylmethane dye, cyanine dye, amorphous silicon, amorphous selenium, trigonal selenium, tellurium, selenium-tellurium alloy, cadmium sulfide, antimony sulfide, and zinc sulfide.

13. The electrophotographic photoreceptor of claim 10, wherein the hole transport material is at least one selected from the group consisting of pyrene compounds, carbazole compounds, hydrazone compounds, oxazole compounds, oxadiazole compounds, pyrazoline compounds, arylamine compound, arylmethane compounds, benzidine compounds, thiazole compounds and styryl compounds.

14. The electrophotographic photoreceptor of claim 10, wherein the electron transport material is at least one selected from the group consisting of electron attracting low-molecular weight compounds including benzoquinone compounds, cyanoethylene compounds, cyanoquinodimethane compounds, fluorenone compounds, xanthones compounds, phenanthraquinone compounds, anhydrous phthalic acid compounds, thiopyrane compounds and diphenoquinone compounds, electron transporting polymer compounds and electron transporting pigments.

15. The electrophotographic photoreceptor of claim 10, wherein the photosensitive layer further comprises a binder resin.

16. The electrophotographic photoreceptor of claim 15, wherein the binder resin is at least one selected from the group consisting of polycarbonate, polyester, methacryl resin, acryl resin, polyvinyl chloride, polyvinylidene chloride, polystyrene, polyvinyl acetate, silicon resin, silicon-alkyd resin, styrene-alkyd resin, poly-N-vinylcarbazole, phenoxy resin, epoxy resin, polyvinyl butyral, polyvinyl acetal, polyvinyl formal, polysulfone, polyvinyl alcohol, ethyl cellulose, phenol resin, polyamide, carboxy-metal cellulose and polyurethane.

17. The electrophotographic photoreceptor of claim 1, wherein the thickness of the photosensitive layer is in a range of 5 to 50 μm.

18. The electrophotographic photoreceptor of claim 1, wherein the photosensitive layer includes at least one additive selected from the group consisting of a plasticizer, a leveling agent, a dispersion- stabilizing agent, an antioxidant and a photo-stabilizing agent.

19. A liquid toner for electrophotographic development employing the photoreceptor claimed in claim 1.

20. An electrophotographic drum, comprising:
a drum; and
an electrophotographic photoreceptor disposed thereon, the electrophotographic photoreceptor comprising:
a support,
an undercoating, and
a photosensitive layer;
wherein the undercoating includes a charge transport material which is soluble in an organic solvent and a binder resin.

21. The electrophotographic drum of claim 20, wherein the charge transport material in the undercoating is a compound represented by Formula 1: 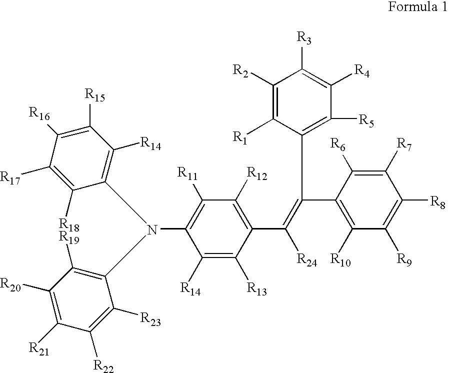
wherein R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉, R₂₀, R₂₁, R₂₂, R₂₃, and R₂₄ are independently selected from the group consisting of a hydrogen atom, a halogen atom, a hydroxy group, a carboxyl group, a cyano group, a amino group, a nitro group, a C₁-C₂₀ optionally substituted alkyl group, a C₆-C₃₀ optionally substituted aryl group, a C₁-C₂₀ optionally substituted halogenated alkyl group, a C₇-C₃₀ optionally substituted aralkyl group, and a C₁-C₂₀ optionally substituted alkoxy group,
wherein the electrophotographic drum is attachable to/detachable from an image forming apparatus.

22. An electrophotographic cartridge, comprising:
an electrophotographic photoreceptor disposed on a drum, the electrophotographic photoreceptor comprising:
a support;
an undercoating; and
a photosensitive layer,
wherein the undercoating includes a charge transport material which is soluble in an organic solvent and a binder resin; and
at least one of:
a charging device that charges the electrophotographic photoreceptor,
a developing unit which develops an electrostatic latent image formed on the electrophotographic photoreceptor, and
a cleaning device which cleans a surface of the electrophotographic photoreceptor;
wherein the electrophotographic cartridge is attachable to/detachable from an image forming apparatus.

23. The electrophotographic cartridge of claim 22, wherein the charge transport material in the undercoating is a compound represented by Formula 1: 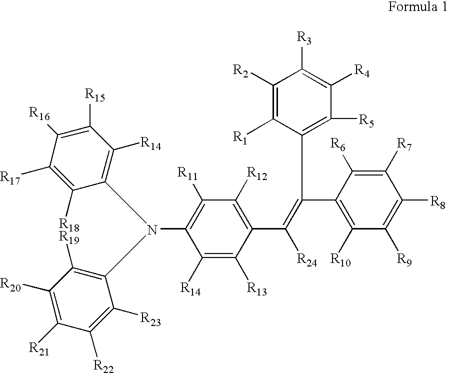
wherein R₁, R₂, R₃, R₄, R₅, R₆, R₇, R₈, R₉, R₁₀, R₁₁, R₁₂ R₁₃, R₁₄, R₁₅, R₁₆, R₁₇, R₁₈, R₁₉, R₂₀, R₂₁, R₂₂, R₂₃, and R₂₄ are independently selected from the group consisting of a hydrogen atom, a halogen atom, a hydroxy group, a carboxyl group, a cyano group, a amino group, a nitro group, a C₁-C₂₀ optionally substituted alkyl group, a C₆-C₃₀ optionally substituted aryl group, a C₁-C₂₀ optionally substituted halogenated alkyl group, a C₇-C₃₀ optionally substituted aralkyl group, and a C₁-C₂₀ optionally substituted alkoxy group,

24. An image forming apparatus, comprising:
a photoconductor unit having an electrophotographic photoreceptor, the electrophotograpohic photoconductor comprising:
a support,
an undercoating, and
a photosensitive layer,
wherein the undercoating includes a charge transport material which is soluble in an organic solvent and a binder resin;
a charging device which charges the photoconductor unit;
an imagewise light irradiating device which irradiates the charged photoconductor unit with imagewise light to form an electrostatic latent image on the photoconductor unit;
a developing unit that develops the electrostatic latent image with a toner to form a toner image on the photoconductor unit; and
a transfer device which transfers the toner image onto a receiving material,

25. The image forming device of claim 24, wherein the charge transport material in the undercoating is a compound represented by Formula 1: 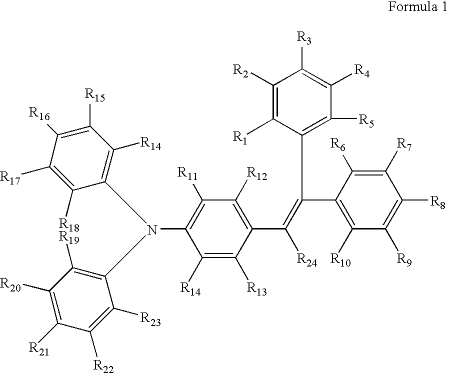
wherein R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉, R₂₀, R₂₁, R₂₂, R₂₃, and R₂₄ are independently selected from the group consisting of a hydrogen atom, a halogen atom, a hydroxy group, a carboxyl group, a cyano group, a amino group, a nitro group, a C₁-C₂₀ optionally substituted alkyl group, a C₆-C₃₀ optionally substituted aryl group, a C₁-C₂₀ optionally substituted halogenated alkyl group, a C₇-C₃₀ optionally substituted aralkyl group, and a C₁-C₂₀ optionally substituted alkoxy group.
